(19) United States
(12) Patent Application Publication
(10) Pub. No.: US 2024/0315360 A1
(43) Pub. Date: Sep. 26, 2024

(54) CHUTE SUIT

(71) Applicant: Joseph Randall Herbst, West Lafayette, IN (US)

(72) Inventor: Joseph Randall Herbst, West Lafayette, IN (US)

(21) Appl. No.: 18/188,602

(22) Filed: Mar. 23, 2023

(51) Int. Cl. A41D 13/00

(52) U.S. Cl. CPC A41D 13/0015; A41D 2400/24; A41D 2600/10; B64D 17/025

(57) ABSTRACT

A flying garment includes a suit having interconnected torso, groin, sleeves, and leg portions with more than one parachute sail joined to a rear of the suit forming interconnected parachute chambers have a rectangular prismatic shape in an air-filled condition, tapering from shoulders to ankle hems and a wing portion joined to a front of the suit. The wing portion interconnects each sleeve portion with the torso portion, interconnects each leg portion with the groin portion, and interconnects the leg portions. The chambers have an opening at a first end to receive air entering the chamber. The parachute sails interconnecting each sleeve portion with one of the leg portions and interconnect the leg portions.

### BACKGROUND OF THE INVENTION

The present invention relates to a flying suit and, more particularly, to a chute suit.

Skydivers need a parachute when jumping from an airplane to slow their descent to a safe speed. The skydiver must wear the parachute and then repack it when the skydiver is back on the ground, delaying the turn-around time for flights. Buildings, Antennae, Spans, and Earth (BASE) jumpers likewise must use a parachute and repack it prior to re-use.

In the event of a fire in a high-rise building, fire ladders cannot reach the top floors and parachutes cannot be used to save lives from a burning building.

As can be seen, there is a need for a device for both skydiving and safe descent from a high-rise building that does not need to be repacked after use.

### SUMMARY OF THE INVENTION

In one aspect of the present invention, a flying garment comprises a suit having interconnected torso, groin, sleeves, and leg portions; more than one parachute sail joined to a rear of the suit to form interconnected parachute chambers having an opening at a first end operative to receive air entering the chamber, the more than one parachute sails interconnecting each sleeve portion with one of the leg portions and interconnecting the leg portions, wherein the chambers have a substantially rectangular prismatic shape in an air-filled condition, tapering from shoulders to ankle hems; and a wing portion joined to a front of the suit, interconnecting each said sleeve portion with said torso portion, interconnecting each leg portion with the groin portion, and interconnecting the leg portions.

The inventive device may be used by anyone with little or no instruction to fly, rather than fall at a high rate of speed, for recreation or safety. People can put it on and save themselves without little instruction when jumping. A user may land and then go back for another jump without having to repack.

These and other features, aspects and advantages of the present invention will become better understood with reference to the following drawings, description, and claims.

### BRIEF DESCRIPTION OF THE DRAWINGS

FIG. 1 is a perspective view of a parachute suit according to an embodiment of the present invention;

FIG. 2 is a bottom perspective view thereof;

FIG. 3 is a front elevation view thereof;

FIG. 4 is a bottom plan view thereof;

FIG. 5 is a detail side view thereof;

FIG. 6 is a detail bottom view of an arm zipper thereof; and

FIG. 7 is a detail bottom view of a leg zipper thereof.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a garment that merges a skydiving suit (i.e., a “jumpsuit”), tailored to fit snugly on the body, with a parachute. The garment is configured to enable a wearer to fly.

The chute suit is sometimes referred to as the “Herbst Chute Suit”.

In some embodiments, the chute suit may further comprise a helmet.

The chute suit may be made from a material having high strength and durability, such as Supplex® fabric.

To manufacture a chute suit, the manufacturer may cut out substantially square sails from a parachute as well as material to make an underside “wing”. The chute suit may comprise a jumpsuit having a main body zipper as well as zippers on the wrists (under forearm to the wrist bone) and from the outside ankle bone to the middle of the calf, making it easier to get one's arms and feet out of the snugly fitting suit. A portion of the parachute may be sewn to the jump suit, leaving a hole for the user's head in the center. Four sails may be joined to the Supplex® fabric to the arms and the back of the suit, such as by stitching. The manufacturer may pin the sails on the jump suit while it is worn or on a tailor's dummy, with the sail portion slightly to the forearm-side of the arms, forming it to a shape that achieves greater lift. The sails may be sewn from wrist to wrist across the back with arms stretched out and from each wrist to the outside of each ankle with legs spread out, leaving a portion at the wrists and ankles held together with Velcro® or other hook-and-loop fastener material for easy access to the zippers for donning and doffing. Left and right rear corners with a section of approximately 4″ 45° may be cut out of the sails to enable air to escape faster and to stabilize the person in flight. Air may also escape through the material.

The inventive chute suit may be used by persons untrained as a skydiver. Individuals trained as a skydiver may retrain their posture in the air as well as the “shape” maintained when landing. The users preferably pass flight tests in a wind tunnel to get the “feel” for flying.

To use the inventive chute suit, the user may get into it like any prior art jumpsuit and zip up zippers at the legs, the arms, and the torso. Then the user may jump such that the air flows from head to toe. The air enters big openings in the front and exits through the fabric and little side “vents” for stabilization, urging airflow along a predetermined path through the suit. The user preferably keeps their mind on the flight and their surroundings as well as the “feel” of all around, staying diligent and aware. The mindset of a user should be like a bird in flight as well as when landing. When jumping out of a plane, the user “hugs” themself to keep the parachute portion from catching air until they are clear of the plane/structure. Once out of the plane, the user may extend arms and legs slowly to inflate sails and form a wing underneath. Once inflated, the person may arc themselves like a plane wing as best as possible to maintain maximum glide angle as well as to maximize “hang” time in the sky. To turn, the user may rotate hips one way or the other, causing one leg to dip. To increase speed, the person may sweep their arms backwards, although less flight time is achieved. (CAUTION: Do not spread arms out quickly to slow down, as the suit may become unstable. Legs and arms should act in unison.) To land on the feet or belly, the user may stay in the arc, keeping the top portion pointed forward to capture air in the “sails” to slow down using ground effect, and may rotate legs to the ground to maintain lift.

In some embodiments, the suit may be configured such that a user may take off from the ground on windy days (e.g., 30+ mph). A tether having a length of at least about 500 ft. may provide tension, enabling the user to get into a suitable shape/arc for takeoff. The tether may be fastened to a center point of a harness worn under the suit. Once the user reaches the height of the tether, it may be released so that the user may fly free in the sky, eliminating the need for a plane ride. The user may then land as usual, accounting for the high wind speed.

“Sails” may have a length equal to the distance from shoulder height, with arms spread out, to the ankles, with legs spread out. The under-portion wing may be the same size as the combined “sail” portions.

“Sail” size may vary depending on the weight and size of the person flying to produce a surface area suitable to provide lift compared to body weight, i.e., the size of the “sails” depends on the user's BMI. For example, 190 sq. ft. main parachute with four of the “sails” taken off may be suitable for a user having a weight of about 155+/−5 lbs. and a height of about 5′9″. The suit may have bigger “sails”, such as from a 200 sq. ft. parachute. The proportions of the user's torso and extremities may also affect the dimensions of the sails and the function of the suit. The size of the “sail” is inversely proportional to speed, as it increases lift and drag.

A reserve parachute may be incorporated into the suit. The reserve chute may be packed differently before flight than prior art methods. The harness for the reserve chute is preferably lighter than a prior art harness while maintaining the strength of the prior art harness. In some embodiments, a main and reserve parachute may be incorporated into the suit for a user with a high body-mass index (BMI).

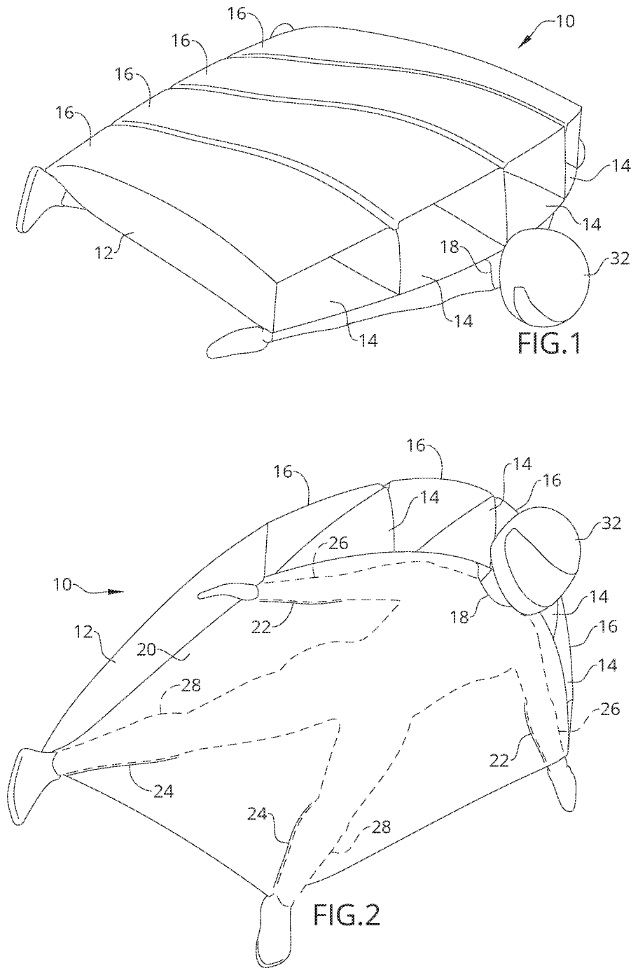

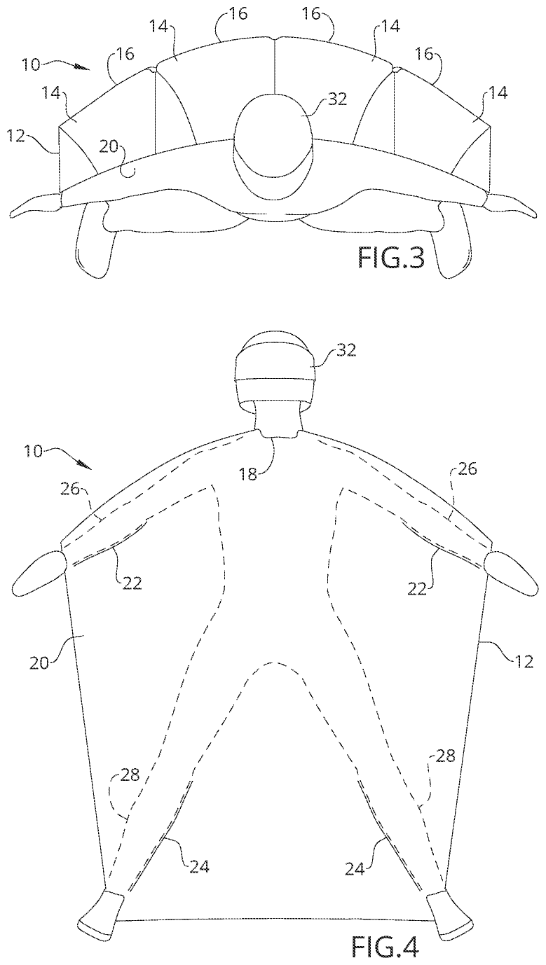

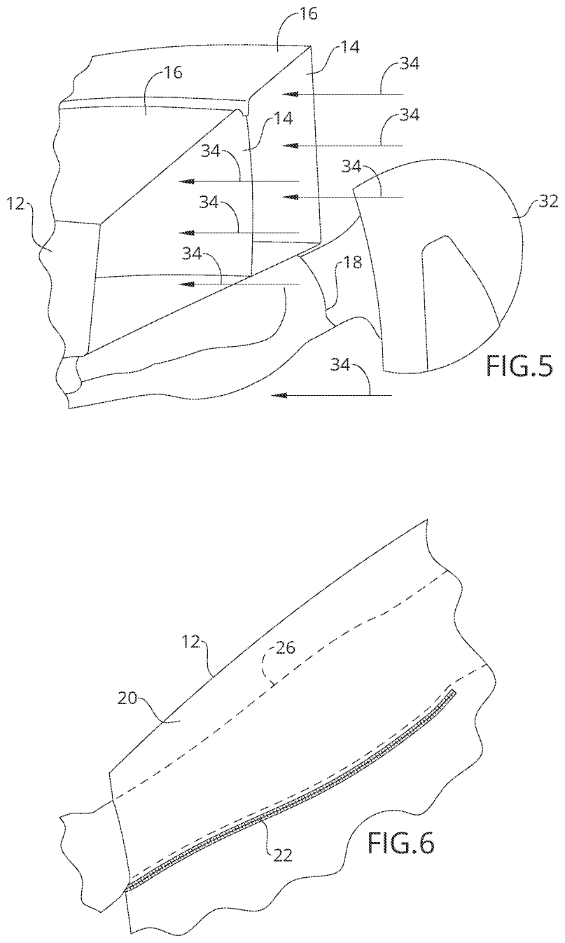

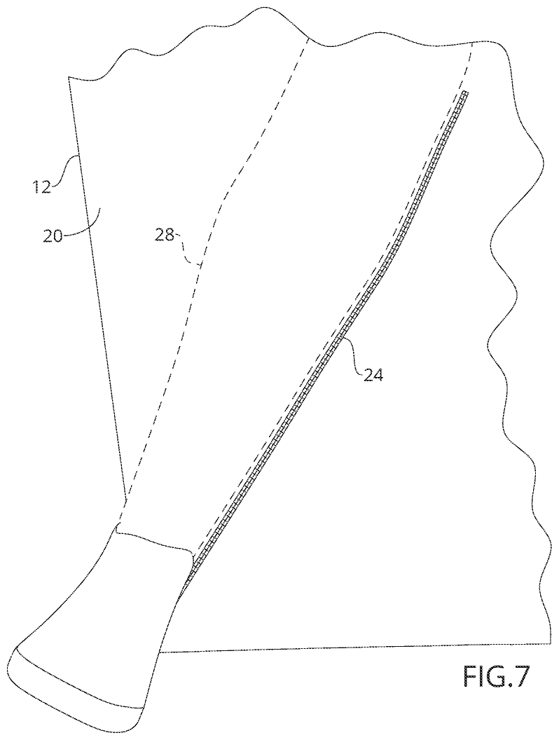

Referring to FIGS. 1 through 7, a chute suit 10 according to an embodiment of the present invention is shown in use, worn by a user 30 with a helmet 32. A parachute 12 with sails 16 forming four parachute cavities 14 extends from the user's arms 26 to the ankles of the user's legs 28. The cavities 14 each have a substantially rectangular prismatic shape, tapering from the head to the ankles. The parachute 12 is joined to an underside wing 20 with a head aperture or cutout 18 that extends from the suit's 10 arms 26 to the suit's 10 legs 28. Arm zippers 22 extend from wrist to elbow and leg zippers 24 extend from ankle to knee, making the suit 10 easier to put on and take off. A torso zipper is not shown. A harness (not shown) may be worn under the suit to enable use with a tether. As shown in FIG. 5, the suit 10 is configured to accommodate air 34 flowing from the user's 30 head to the user's 30 feet.

It should be understood, of course, that the foregoing relates to exemplary embodiments of the invention and that modifications may be made without departing from the spirit and scope of the invention as set forth in the following claims.

What is claimed is:

1. A flying garment, comprising:
a suit having interconnected torso, groin, sleeves, and leg portions;
more than one parachute sail joined to a rear of the suit to form interconnected parachute chambers having an opening at a first end operative to receive air entering the chamber, the more than one parachute sails interconnecting each sleeve portion with one of the leg portions and interconnecting the leg portions, wherein the chambers have a substantially rectangular prismatic shape in an air-filled condition, tapering from shoulders to ankle hems; and
a wing portion joined to a front of the suit, interconnecting each said sleeve portion with said torso portion, interconnecting each leg portion with the groin portion, and interconnecting the leg portions.

2. The flying garment of claim 1, wherein the suit has four parachute chambers.

3. The flying garment of claim 1, wherein the more than one parachute sail has a vent to urge airflow along a predetermined path through the suit.

4. The flying garment of claim 1, wherein an aperture is formed in the torso portion for a user's head.

5. The flying garment of claim 1, further comprising zippers effective to enable donning and doffing of the suit.

6. The flying garment of claim 5, wherein the zippers extend on the sleeves from wrist to elbow.

7. The flying garment of claim 5, wherein the zippers extend on the leg portions from ankle to knee.
